(19) United States
(12) Patent Application Publication
(10) Pub. No.: US 2008/0155106 A1
(43) Pub. Date: Jun. 26, 2008

(54) Method For Forming a Common Communication Session, Method For Forming a First Communication Session and a Second Communication Session From a Common Communication Session, and Communication Session Server

(75) Inventors: Martin Hans, Bad Salzdetfurth (DE); Andreas Schmidt, Braunschweig (DE); Norbert Schwagmann, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/911,230

(22) PCT Filed: Mar. 28, 2006
(86) PCT No.: PCT/DE06/00551

§ 371 Date: Nov. 2, 2007

(30) Foreign Application Priority Data
Apr. 11, 2005 (DE) 10 2005 016 587.7

(51) Int. Cl. G06F 15/16

(52) U.S. Cl. 709/227

(57) ABSTRACT

Communication control server and method for forming a common communication session from a first and second communication sessions, each with a plurality of communication session participant communication devices, which are respectively associated with a respective participant server and use the respective participant server to participate in the respective communication session. Each of the first and second communication sessions is controlled by a respective communication session control server. A request to combine the communication session participant communication devices in the common communication session prompts one of the two communication session control servers to request a common communication session from the other communication session control server using a fusion request message. One of the two communication session control servers sets up the common communication session and transmits a fusion message to each of the participant servers. The respective participant server associates its associated communication session participant communication device with the common communication session.

### CROSS-REFERENCE TO RELATED APPLICATION

This application claims priority to International Patent Application Serial No. PCT/DE2006/000551, filed Mar. 28, 2006, which published in German on Oct. 19, 2006 as WO/2006/108379, and is incorporated herein by reference in its entirety.

### BACKGROUND OF THE INVENTION

The invention relates to a method for forming a common communication session, a method for forming a first communication session and a second communication session from a common communication session, and a communication session control server.

The communication service Push-to-talk-over-Cellular (PoC) (described in Push-to-talk over Cellular (PoC); Architecture; PoC Release 1.0, Architecture V 1.1.0, 2003-08, and Push-to-talk over Cellular (PoC); List Management and Do-not-Disturb; PoC Release 1.0, List Management and Do-not-Disturb V 1.1.3, 2003-08, for example) allows a user of a mobile radio subscriber terminal to transmit voice data to one or more recipients simultaneously.

To this end, a special PoC key is typically provided on the mobile radio subscriber terminal which, when it has been operated, allows the user to start entering voice data in spoken form.

The voice data are usually distributed, that is to say transmitted to the desired recipient(s), by means of a mobile radio communication network while they are actually being entered. This process is called “streaming”.

The transmission is effected using the half-duplex method, that is to say that during entry and during transmission only the sender, that is to say the user who is entering and sending the voice data, can transmit voice data to the recipients, but the recipients cannot simultaneously send voice data to the sender. In particular, the sender cannot be interrupted by the recipients.

As a good example, from the point of view of the user, communication using PoC corresponds to conventional CB radio, but with the enhancement that the sender can transmit voice data worldwide to recipients who can be reached by means of the suitable switching technology of at least one mobile radio communication network.

When a plurality of Push-to-talk-over-Cellular communication sessions (PoC communication sessions, PoC sessions) have been set up, it may be desirable to combine a plurality of PoC communication sessions at least temporarily to form a common PoC communication session. This situation is illustrated below.

Users A, B and C, i.e. their communication devices, communicate with one another in a first PoC session. Users A, D and E, i.e. their communication devices, simultaneously communicate with one another in another, second PoC session. User A (who is involved in both PoC sessions) now notices that the same subject is currently being discussed in both PoC sessions. It therefore makes sense to user A for all the users in both PoC sessions to be able to communicate jointly in a common PoC session (at least for as long as the subject is being discussed). As soon as the subject has ended, user A would then like to conduct the originally separate PoC sessions (i.e. the first PoC session and the second PoC session) separately again, i.e. to continue them independently of one another.

The situation being considered by way of example in this description is as follows:
Two mutually independent PoC sessions are in progress.
A PoC user has dialed into the two, in general terms into a plurality of, PoC sessions simultaneously (this is not necessary but is initially assumed in the descriptions below, since this is the most likely case).
All the users in the two PoC sessions, in general terms the plurality of PoC sessions, need to be able to communicate with one another jointly for a certain period in a common PoC session.

On the basis of the prior art, it would be possible to achieve this aforementioned objective using the conference state notification service described in RFC3265 “Session Initiation Protocol (SIP)-Specific Event Notification,” and draft-ietf-sipping-conference-package-08 “A Session Initiation Protocol (SIP) Event Package for Conference State,” which is optionally provided for PoC. In this case, user A can use the conference state notification service to ascertain the participants in the second PoC session, which is to be combined with the first PoC session to form a common PoC session. User A then invites all the participants in the second PoC session individually to join the first PoC session. When these users (user D and user E in the example above) have accepted this invitation, they are likewise participants in the first PoC session. It is therefore now possible for all the participants from the two PoC sessions to communicate with one another in the common PoC session.

This possible solution based on the prior art has the following drawbacks, inter alia, however:
If the second PoC session has a large number of participants then this results in a high level of signaling complexity for user A in order to invite all the participants in the second PoC session individually to join the common PoC session.
States of the PoC communication sessions (PoC session statuses) which existed in the second PoC session at the time of the change, i.e. the transition to the common PoC session, cannot be included in the common PoC session, for example the first PoC session continued as the common PoC session. An example of one such status in this case is what is known as the floor control queue).
User D and user E need to handle two PoC sessions in parallel. Since parallel handling of a plurality of PoC sessions is an optional service feature (feature) in the current PoC communication standard, problems arise for PoC clients which do not support this service feature. As soon as they accept the invitation to join the temporarily common first PoC session, they then need to release the second PoC session, as a result of which they lose the relevant context relating to the original second PoC session. Neat isolation of the temporary common PoC session, i.e. later continuation of the second PoC session in the original context, is no longer possible.
Problems may arise even if all the PoC clients involved are in control of parallel handling of a plurality of PoC sessions: with parallel PoC sessions, a user can lock a PoC session, i.e. he selects that he wishes to receive only voice messages from the locked PoC session. If a user has originally locked the second PoC session, is invited to join the first PoC session and then misses the opportunity to cancel the lock for the second PoC session or to switch, i.e. change over, the lock to the first PoC session, he does not get anything from the communication in the temporary common first PoC session.

U.S. Pat. No. 5,195,086 A discloses a method in which a first telephone conference between a first set of communication terminals and a second telephone conference between a second set of communication terminals can be merged to form a single telephone conference. In addition, a telephone conference can be split into a first telephone conference between a first set of communication terminals and a second telephone conference between a second set of communication terminals.

### BRIEF DESCRIPTION OF THE DRAWINGS

Exemplary embodiments of the invention are illustrated in the figures and are explained in more detail below. Where expedient, identical or similar units have been provided with the same reference symbols in the figures.

In the figures:

FIG. 1 shows a block diagram showing a PoC communication network based on the prior art;

FIG. 2 shows a message flow diagram showing the interchange of messages for forming a common communication session on the basis of a first exemplary embodiment of the invention;

FIG. 3 shows a block diagram showing a PoC communication network after a common communication session has been formed on the basis of a first exemplary embodiment of the invention;

FIG. 4 shows a message flow diagram showing the interchange of messages for splitting the common communication session formed as shown in FIG. 1 over two communication sessions on the basis of the first exemplary embodiment of the invention;

FIG. 5 shows a message flow diagram showing the interchange of messages for forming a common communication session on the basis of a second exemplary embodiment of the invention and also fresh splitting thereof into the two communication sessions; and

FIG. 6 shows a block diagram showing a PoC communication network after a common communication session has been formed on the basis of a second exemplary embodiment of the invention.

### DETAILED DESCRIPTION OF THE PREFERRED EMBODIMENTS

The invention is based on the problem of forming a common communication session from a plurality of communication sessions proceeding independently of one another and of forming a plurality of independently proceeding communication sessions from a common communication session more easily in comparison with the above method.

The problem is solved by a method for forming a common communication session, by a method for forming a first communication session and a second communication session from a common communication session, and by communication session control servers with the features based on the independent patent claims.

Exemplary refinements of the invention can be found in the dependent patent claims. The refinements of the invention which are described below apply, as far as it makes sense in each case, to the methods and to the communication session control servers.

A method for forming a common communication session from a first communication session with a plurality of communication session participant communication devices and a second communication session with a plurality of communication session participant communication devices, where the first communication session is controlled by a first communication session control server, and where the second communication session is controlled by a second communication session control server, involves a request to combine the communication session participant communication devices in the common communication session prompting one of the two communication session control servers to request a common communication session from the other communication session control server using a fusion request message. In addition, one of the two communication session control servers sets up the common communication session.

A method for forming a first communication session with a plurality of communication session participant communication devices and a second communication session with a plurality of communication session participant communication devices from a common communication session, where the first communication session is controlled by a first communication session control server, and where the second communication session is controlled by a second communication session control server, involves a request to split the communication session participants from the common communication session over the first communication session and the second communication session prompting one of the two communication session control servers to associate the communication session participant communication devices with the first communication session and the second communication session. In addition, one of the two communication session control servers uses a split message to notify the other communication session control server of the splitting of the communication session participant communication devices.

A communication session control server for forming a common communication session from a first communication session with a plurality of communication session participant communication devices and a second communication session with a plurality of communication session participant communication devices, where the first communication session is controlled by the communication session control server, and where the second communication session is controlled by another communication session control server, has a processor which is set up such that the following method steps can be performed:
a request to combine the communication session participant communication devices in the common communication session prompts the communication session control server to request a common communication session from the other communication session control server using a fusion request message, and
the communication session control server sets up the common communication session.

Another communication session control server for forming a common communication session from a first communication session with a plurality of communication session participant communication devices and a second communication session with a plurality of communication session participant communication devices, where the first communication session is controlled by the communication session control server, and where the second communication session is controlled by another communication session control server, has a processor which is set up such that receipt of a fusion request message from another communication session control server, which message is used to request a common communication session, prompts it to set up the common communication session.

In line with another aspect of the invention, a communication session control server for forming a first communication session with a plurality of communication session participant communication devices and a second communication session with a plurality of communication session participant communication devices from a common communication session, where the first communication session is controlled by the communication session control server, and where the second communication session is controlled by another communication session control server, is provided, the communication session control server having a processor which is set up such that the following method steps can be performed:
a request to split the communication session participants from the common communication session over the first communication session and the second communication session prompts the communication session control server to associate the communication session participant communication devices with the first communication session and the second communication session, and
the communication session control server uses a split message to notify the other communication session control server of the splitting of the communication session participant communication devices.

Hence, this invention clearly provides a simple way of solving the problem of how two sessions (communication sessions) which are initially proceeding independently of one another can be merged to form a group-based service (such as PoC) and can also be split into the two sessions (communication sessions) proceeding independently of one another again.

In line with one refinement of the invention, provision is made for the request, for example in the form of a fusion request message, to be sent by a communication session participant communication device in the first communication session and/or by a communication session participant communication device in the second communication session.

This provides a very simple way for a participant in one of the proceeding communication sessions, alternatively a participant in both proceeding communication sessions, in the case of more than two proceeding communication sessions a participant from two or more, including all, proceeding communication sessions, to be able to initiate the combination of a prescribable number of proceeding communication sessions to form a common communication session.

The first communication session control server can set up the common communication session.

In this case, one refinement of the invention provides for the fusion request message to contain a communication session identification statement for the second communication session, for example the session ID of the second communication session, alternatively a statement which allows the second communication session control server to identify the second communication session.

In addition, the second communication session control server may be set up such that it produces an acknowledgement message and transmits it to the first communication session control server.

In this way, the first communication session control server is reliably notified that it can clearly add the second communication session to the first communication session it is controlling, in general terms that it can combine the first communication session and the second communication session to form the common communication session.

In one refinement of the invention, provision is also made for the acknowledgement message to contain a list of the communication session participant communication devices in the second communication session, the list being able to contain an explicit address for the respective communication session participant communication devices in the second communication session or a reference to an identification statement which can be used to explicitly identify the communication session participant communication devices in the second communication session.

The acknowledgement message designed in this manner is used to specify a very simple mechanism that is used to inform the first communication session control server about the communication session participant communication devices in the second communication session, so that it can add these to the common communication session. In this context, it should be noted that when the first communication session control server sets up the common communication session, the identities or the addresses of the communication session participant communication devices in the first communication session are known.

In one alternative refinement of the invention, provision is made for a communication session control server which up to this time is not controlling any of the hitherto proceeding communication sessions to set up the common communication session. In this case, provision is made for the communication session control server to be provided with the addresses of the communication session participant communication devices or with the information required in order to identify them both from the communication session participant communication devices in the first communication session and from the communication session participant communication devices in the second communication session, for example by the respective communication session control servers.

In addition, the acknowledgement message may contain a piece of information about the communication rights allocation of the communication session participant communication devices in the second communication session.

The piece of information about the communication rights allocation of the communication session participant communication devices in the second communication session has a piece of communication rights queue information, for example, which is used to indicate the future communication rights allocation of the communication session participant communication devices in the second communication session.

Other possible information is:
What priorities do the individual participants in the second PoC session have regarding floor allocation?; this is because the users may have different priorities, i.e. a higher-priority user comes before a lower-priority user in the queue, even though he may have made a later request;
Generally: what rights did a user have in the second session?; example: is he actually permitted to request the floor, or is he permitted only to listen? Is he permitted to invite other users to join the session? What information is the user permitted to request?
What media have been used in the second session?; although PoC currently allows only voice, in future it will also allow video, messaging, files etc.

All these and further statuses are recorded and managed during conferencing (based on IETF and 3GPP) in what are known as the conference policy document (state of the session, rules in the session, state of the users), media policy document (rules of floor allocation, which media are permitted to be and are used) and conference policy privileges document (what rights do the users have to change the entries in the first two documents).

In this connection, it should be noted that when the invention is applied to internet conferencing, for example, a conferencing framework being described in J. Rosenberg, A framework for conferencing with the session initiation protocol, SIP Internet-Draft, IETF SIPPING working group: Draft-IETF-SIPPING-conferencing-framework-02, June 2004, for example, the documents described above can be transmitted at the same time as information media. Alternatively, it is also possible for an explicit reference to such a document, for example in the form of the respective explicit identification statement (ID) associated with a document, to be transmitted at the same time.

In line with one refinement of the invention, this piece of communication rights queue information, for example the QueueStatus information item in the case of PoC, is taken into account in the communication rights allocation in the common communication session. Generally, this means that the communication rights allocation in the common communication session is performed taking account of the piece of information about the communication rights allocation of the communication session participant communication devices in the first communication session and/or the second communication session.

In one alternative refinement of the invention, the second communication session control server can set up the common communication session.

In this case, the fusion request message may contain a communication session identification statement for the first communication session.

By way of example, provision is made for the fusion request message to contain a list of the communication session participant communication devices in the first communication session, the list being able to contain an explicit address for the respective communication session participant communication devices in the second communication session or a reference to an identification statement which can be used to explicitly identify the communication session participant communication devices in the second communication session.

The fusion request message may also contain a piece of information about the communication rights allocation of the communication session participant communication devices in the first communication session, the piece of information about the communication rights allocation of the communication session participant communication devices in the first communication session being able to have a piece of communication rights queue information which is used to indicate the future communication rights allocation of the communication session participant communication devices in the first communication session.

In line with one refinement of the invention, the communication rights allocation in the common communication session is performed taking account of the information about the communication rights allocation of the communication session participant communication devices in the first communication session and/or the second communication session.

In line with another aspect of the invention, provision is made for the communication session control server setting up the common communication session to transmit a fusion message to each of the participant servers of the communication session participant communication devices in the first communication session and/or the second communication session, and for the respective participant server to associate its associated communication session participant communication device with the common communication session.

Clearly, with hierarchic structuring of communication session servers in a plurality of hierarchy levels, this refinement of the invention means that the respective piece of information about the combination of the communication sessions is forwarded from the communication session control server on the top hierarchy level to one or more communication session servers on one or more subordinate hierarchy levels, and the combination of the communication sessions or respective data streams from the communication session participants is adopted by the “subordinate” communication session server(s). In the exemplary instance of PoC, where, in addition to the communication session control servers there is also a participant server for at least one communication session participant device, for example a mobile radio terminal, said participant server taking over the relevant association of the transmitted data streams (i.e. both when they are multiplexed and when they are demultiplexed) to the common communication session.

The Session Initiation Protocol (SIP) can be used at least for some of the messages, in other words at least some of the messages can be encoded and transmitted on the basis of the SIP.

The communication sessions may be Push-to-talk communication sessions, for example Push-to-talk-over-Cellular communication sessions (PoC communication sessions, PoC sessions).

It should be noted that the invention can also be used within the context of another communication architecture in which (for example temporary) combination of two communication sessions, inherently proceeding independently of one another, to form a common communication session is to be achieved. One example of this is a conference architecture in which the communication sessions are provided by means of the Internet, i.e. using the Internet Protocol (IP) and the Transport Control Protocol (TCP). This means that the invention is not dependent on the type of data transmission medium used and can be used either in a mobile radio communication network or in a landline communication network or else in a hybrid communication network with a mobile radio communication network section and a landline communication network section. The communication sessions may therefore also be conferencing sessions, for example IMS conferencing or IETF conferencing.

Generally, one refinement of the invention involves all respective available and appropriately usable status information for the two communication sessions being taken into account when forming the common communication session. If the first communication session control server sets up the common communication session, the status information about the second communication session is transmitted from the second communication session control server to the first communication session control server, for example. If the second communication session control server sets up the common communication session, the status information about the first communication session is transmitted from the first communication session control server to the second communication session control server, for example.

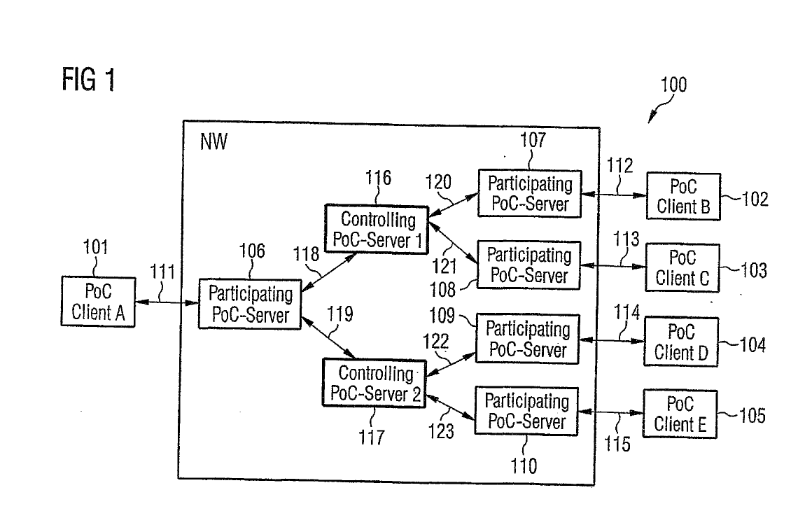

FIG. 1 shows a PoC communication network 100 based on the prior art.

The PoC communication network 100 based on the exemplary embodiments of the invention is designed in the same manner as explained in connection with FIG. 1 apart from the enhancements provided on the basis of the exemplary embodiments of the invention.

FIG. 1 shows five PoC clients, namely a first PoC client 101, a second PoC client 102, a third PoC client 103, a fourth PoC client 104 and a fifth PoC client 105.

Each PoC client 101, 102, 103, 104, 105 is integrated, i.e. implemented, in a respective communication terminal (not shown), for example a mobile radio communication terminal, for example a mobile radio telephone or a Personal Digital Assistant (PDA).

Each PoC client 101, 102, 103, 104, 105 or its communication terminal is associated with a respective participating PoC server 106, 107, 108, 109, 110, subsequently also referred to as participant server, by means of an interface and is coupled to said participating PoC server by means of a mobile radio communication link 111, 112, 113, 114, 115 (air interface), for example on the basis of one of the following mobile radio communication standards, for example a 3GPP (3rd Generation Partnership Project) mobile radio communication standard:
Global System for Mobile Communications (GSM);
General Packet Radio Standard (GPRS);
Enhanced Data Service for GSM Evolution (EDGE);
Universal Mobile Telecommunications System (UMTS).

Alternatively, the respective PoC client 101, 102, 103, 104, 105 or its communication terminal may be connected to the respective participating PoC server 106, 107, 108, 109, 110 by means of a PSTN communication link, i.e. by means of a landline communication link.

For each PoC communication session set up between a plurality of PoC communication session participant terminals (which contain the respective PoC clients involved), there is a controlling PoC server 116, 117, subsequently also referred to as PoC communication session control server.

A respective participating PoC server 106, 107, 108, 109, 110 is connected to that controlling PoC server 116, 117 which controls a PoC communication session in which the PoC client 101, 102, 103, 104, 105 of the respective participating PoC server 106, 107, 108, 109, 110 is participating.

In FIG. 1, it is assumed that the first PoC client 101 is participating in a first PoC communication session controlled by the first controlling PoC server 116. For this reason, the first participating PoC server 106 is connected to the first controlling PoC server 116 by means of a first communication link 118. In addition, the first PoC client 101 is participating in a second PoC communication session controlled by the second controlling PoC server 117. For this reason, the first participating PoC server 106 is connected to the second controlling PoC server 117 by means of a second communication link 119.

In addition, the second PoC client 102 is participating in the first PoC communication session controlled by the first controlling PoC server 116. For this reason, the second participating PoC server 107 is connected to the first controlling PoC server 116 by means of a third communication link 120.

The third PoC client 103 is likewise participating in the first PoC communication session controlled by the first controlling PoC server 116, which is why the third participating PoC server 108 is connected to the first controlling PoC server 116 by means of a fourth communication link 121.

The fourth PoC client 104 is participating in the second PoC communication session controlled by the second controlling PoC server 117, which is why the fourth participating PoC server 109 is connected to the second controlling PoC server 117 by means of a fifth communication link 122.

The fifth PoC client 105 is likewise participating in the second PoC communication session controlled by the second controlling PoC server 117, which is why the fifth participating PoC server 110 is connected to the second controlling PoC server 117 by means of a sixth communication link 123.

The respective participating PoC servers are therefore connected to the respective controlling PoC server 116, 117.

The respective controlling PoC server 116, 117 has, inter alia, the functionality of managing floor allocation (floor control), in general terms communication rights allocation, in the communication session it is managing.

In this example, the first PoC client 101 has therefore dialed into two PoC sessions simultaneously, i.e. its participating PoC server 106 is connected to two different controlling PoC servers, namely to the first controlling PoC server 116 and to the second controlling PoC server 117. If voice messages occur in both PoC sessions simultaneously, only one of the two can be forwarded to the first PoC client 101 on the basis of the prior art.

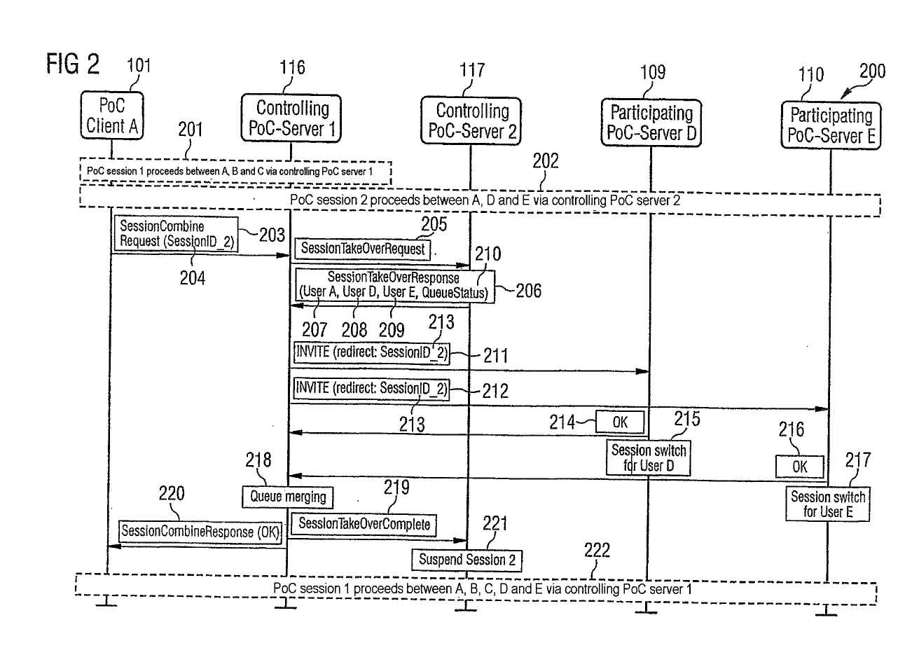

FIG. 2 shows a message flow diagram 200 showing the interchange of Session Initiation Protocol (SIP) messages for forming a common communication session on the basis of a first exemplary embodiment of the invention.

In line with this exemplary embodiment of the invention, it is assumed that a first communication session, which is controlled by the first controlling PoC server 116, has been set up between the first PoC client 101, the second PoC client 102 and the third PoC client 103 (symbolized by block 201 in FIG. 2).

In addition, it is assumed in line with this exemplary embodiment of the invention that a second communication session, which is controlled by the second controlling PoC server 117, has been set up between the first PoC client 101, the fourth PoC client 104 and the fifth PoC client 105 (symbolized by block 202 in FIG. 2).

Generally, it is assumed that the method for combining the two communication sessions to form a common communication session is initiated, in line with this exemplary embodiment, by one of the participants in at least one of the two communication sessions, in line with this exemplary embodiment, to be more precise, by the first PoC client 101, which is participating both in the first communication session and in the second communication session.

The first PoC client 101, which is operated by a first user A, signals to the first controlling PoC server 116 that it wishes to merge the current PoC session, i.e. the first PoC session, with another PoC session, namely the second PoC session. This is done by virtue of the first PoC client 101 producing a request message (SessionCombineRequest) 203 and transmitting it to the first controlling PoC server 116, providing the PoC session ID (as communication session identification statement) of the second PoC session as a parameter.

In this connection, it should be noted that the PoC session ID 204 of the second PoC session is known to the first PoC client 101, since it is also participating in the second PoC session.

If the first controlling PoC server 116 does not support this feature, the first PoC client 101 and hence the first user A is sent an appropriate error message in response.

Receipt of the request message 203 prompts the first controlling PoC server 116 to send a fusion request message (SessionTakeOverRequest) 205 to the second controlling PoC server 117 (whose address is the second PoC session's PoC session ID transferred above). The fusion request message 205 is used to ask the second controlling PoC server 117 whether the first controlling PoC server 116 can merge the first PoC session with the second PoC session controlled by the second controlling PoC server 117.

In this exemplary embodiment, the second controlling PoC server 117 agrees to the request and indicates this to the first controlling PoC server 116 using a fusion acknowledgement message 206, which the second controlling PoC server 117 produces and transmits to the first controlling PoC server 116. The fusion acknowledgement message 206 contains the list of the current participants in the second PoC session (user A 207 on the first PoC client 101, user D 208 on the fourth PoC client 104 and user E 209 on the fifth PoC client 105) and a piece of information describing the current status of the queue (parameter QueueStatus 210) (optionally, if present), and possibly other parameters describing the status of the second PoC session. Alternatively, a link to a document which contains all the statuses relating to the second PoC session (e.g. a conference policy document) may also be transferred as a parameter.

If the second controlling PoC server 117 does not support this feature, the first controlling PoC server 116 likewise receives an appropriate error message in response thereto.

In one alternative embodiment, provision is made for user A on the first PoC client 101 to send the fusion request message (SessionCombineRequest) 203 to the second controlling PoC server 117 (in this case with the session ID of the first PoC session). The second controlling PoC server 117 then asks the first controlling PoC server 116 to merge the two PoC sessions, providing the aforementioned parameters (list of participants in the second PoC session and possibly QueueStatus).

For both embodiments described above, the following steps are now performed.

The first controlling PoC server 116 starts to invite the participants in the second PoC session to join the first PoC session 1, which logically forms a third, common communication session.

In this example, however, this does not apply to user A on the first PoC client 101, since he is already participating in the first PoC session, of course.

As part of the invitation, the first controlling PoC server 116 sends a first SIP-INVITE message 211 to the fourth participating PoC server 109 and a second SIP-INVITE message 212 to the fifth participating PoC server 110. The first SIP-INVITE message 211 and the second SIP-INVITE message 212 contain a respective parameter (redirect: SessionID_{—}2) 213 which is used to indicate that the data stream from the second PoC session needs to be rerouted to the first PoC session by the respective participating PoC server.

The parameter 213 is therefore used to signal that it is not an SIP-INVITE message based on the prior art. The parameter 213 is formed by a flag (redirect) with the parameter from the PoC session in question. This flag prompts the respective participating PoC server 109, 110 not to send an SIP-INVITE message to the relevant PoC clients 104, 105 (as would occur on the basis of the prior art), but rather, clearly, to “redirect” the second PoC session (determined by the parameter 213) for the PoC user to the first PoC session. In other words, this means that the participating PoC server 109, 110 now associates the PoC session of the PoC client 104, 105 with the first controlling PoC server 116 instead of with the second controlling PoC server 117 (symbolized by block 215 for the fourth participating PoC server 109 in FIG. 2, and symbolized by block 217 for the fifth participating PoC server 110 in FIG. 2), without the respective PoC client 104, 105 being aware of this. If appropriate, the PoC clients 104, 105 can also be informed of this and possibly of changed media parameters or of the changed controlling PoC server address by means of an SIP-UPDATE message, however.

The fourth participating PoC server 109 responds to receipt of the first SIP-INVITE message 211 with a first SIP-200-OK message 214 and sends this message to the first controlling PoC server 116.

The fifth participating PoC server 110 responds to receipt of the second SIP-INVITE message 212 with a second SIP-200-OK message 216 and sends this message to the first controlling PoC server 116.

When the first controlling PoC server 116 has received an SIP-200-OK message 214, 216 acknowledging receipt for at least one of the SIP-INVITE messages 211, 212 it has sent, the respective positively acknowledging users are incorporated into the first PoC session and the first controlling PoC server 116 can merge the two queues (if present), or, if desired or expedient, portions thereof. In line with this exemplary embodiment of the invention, this is done by generating the new, enhanced queue for the “merged” common PoC session clearly on the basis of the principle of alternation (step 218). In other words, this means that the communication rights allocation queue (queue) for the common PoC session is formed by constantly alternating, in chronological order, the addition (or maintenance) of an entry from the communication rights allocation queue (queue) for the first PoC session and then the addition of an entry from the communication rights allocation queue (queue) for the second PoC session, etc., to the “new” communication rights allocation queue (queue).

Following successful completion of the combination of the queues of the two PoC sessions, the first controlling PoC server 116 signals to the second controlling PoC server 117 that the merging has been performed successfully. This is done using a communication session takeover message 219 (SessionTakeOverComplete), which the first controlling PoC server 116 produces and transmits to the second controlling PoC server 117. In addition, the first controlling PoC server 116 acknowledges to the first PoC client 101 and hence to user A its SessionCombineRequest sent at the beginning using a request response message 220 (SessionCombineResponse).

Following receipt of the communication session takeover message 219, the second controlling PoC server 117 interrupts the second PoC session (symbolized by block 221 in FIG. 2).

This means that the first PoC session is now a common PoC session in which all five PoC clients 101, 102, 103, 104, 105 are participating (symbolized by block 222 in FIG. 2).

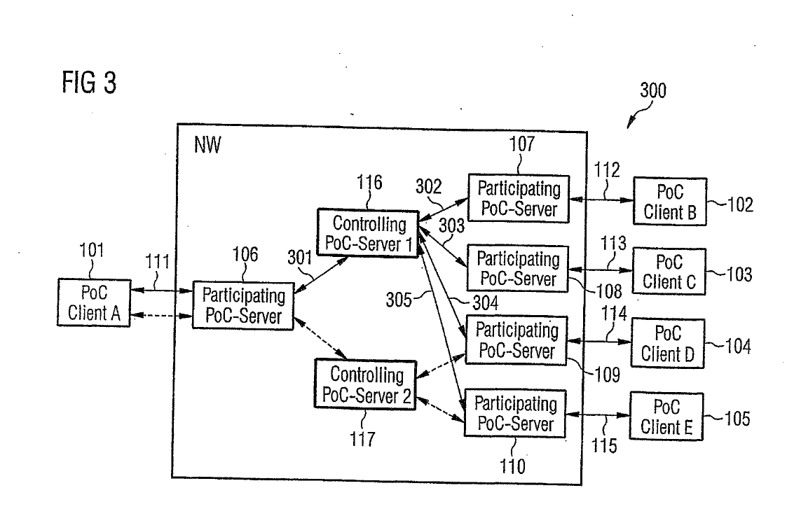

FIG. 3 uses a block diagram 300 to show the state of the communication links in the PoC communication network 100 in terms of the PoC sessions when the first PoC session and the second PoC session have been combined to form the common PoC session in the first PoC session.

The basic structure of the PoC communication network 100 shown in FIG. 3 corresponds to that of the one shown in FIG. 1, but with the communication links between the participating PoC servers 106, 107, 108, 109, 110 and the controlling PoC servers 116, 117 being different. The communication links 111, 112, 113, 114, 115 between the PoC clients 101, 102, 103, 104, 105 and the participating PoC servers 106, 107, 108, 109, 110 are unchanged.

In FIG. 3, there is a communication link 301 between the first participating PoC server 106 and the first controlling PoC server 116 and also a communication link 302, 303, 304, 305 between each of the further participating PoC servers 107, 108, 109, 110 and the first controlling PoC server 116, respectively.

The fourth participating PoC Server 109 from the fourth PoC client 104 and the fifth participating PoC server 110 from the fifth PoC client 105 are therefore now also connected to the first controlling PoC server 116, but also additionally to the second controlling PoC server 116 (shown in dashes in FIG. 3, since no media are interchanged in this case while the two PoC sessions are merged). The fourth PoC client 104 and the fifth PoC client 105 use the same connection to their participating PoC servers 109, 110 as they also used before. The connection between the second controlling PoC server 117 and the first PoC client 101 or its first participating PoC server 106 is also shown in dashes, since temporarily no media are interchanged in this case.

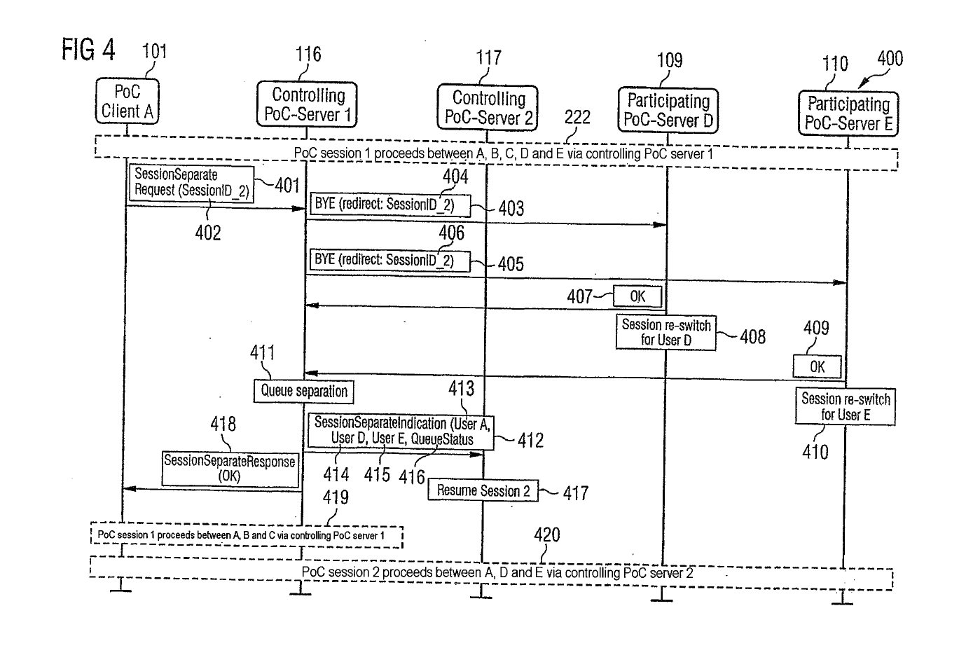

Thus, when the two PoC sessions have been merged, they may also be separated again at some time, i.e. split into the original first PoC session and the second PoC session (see message flow diagram 400 in FIG. 4).

This is also initiated by someone, in the case of this exemplary embodiment of the invention again by the first PoC client 101, i.e. user A.

To this end, an input from user A causes the first PoC client 101 to send a request in the form of a split request message (SessionSeparateRequest) 401 to the first controlling PoC server 116, indicating as parameter 402 the ID of the PoC session which is to be detached in this case, i.e. from the “common” first PoC session.

Receipt of the split request message 401 prompts the first controlling PoC server 116 to signal to the participating PoC servers of the original participants in the second PoC session, i.e. to the fourth participating PoC server 109 and the fifth participating PoC server 110, that the merging is being terminated.

This is done by virtue of the first controlling PoC server 116 producing a first SIP-BYE message 403 and transmitting it to the fourth participating PoC server 109, also supplying the PoC session ID of the original second PoC session as parameter 404. In addition, the first controlling PoC server 116 produces a second SIP-BYE message 405 and transmits it to the fifth participating PoC server 110, also supplying the PoC session ID of the original second PoC session as parameter 406.

The respective participating PoC servers 109, 110 take back the redirection again, so that the original status of the second PoC session is recovered (symbolized by block 408 for the fourth participating PoC server 109 in FIG. 4 and symbolized by block 410 for the fifth participating PoC server 110 in FIG. 4).

When the first controlling PoC server 116 has received all the acknowledgements (a first SIP-200-OK message 407 from the fourth participating PoC server 109 and a second SIP-200-OK message 409 from the fifth participating PoC server 110), it uses a communication session split indicator message (SessionSeparateIndication) 412 to inform the second controlling PoC server 117 that the merging has been cancelled again. In so doing, it removes the relevant participants from the temporarily common queue (queue separation block 411) and supplies this queue 416 together with the current participants belonging to the second PoC session (first PoC client 101 (first participant 413), fourth PoC client 104 (fourth participant 414), fifth PoC client 105 (fifth participant 415)) to the second controlling PoC server as parameters.

In addition, the first controlling PoC server 116 produces a communication session split response message 418 (SessionSeparateResponse(OK)) and sends this message to the first PoC client 101.

The second controlling PoC server 117 then resumes the original second PoC session, so that from this point onward the two PoC sessions proceed independently of one another again (step 417).

The first PoC session now proceeds with the first PoC client 101, the second PoC client 102 and the third client 103 as participants again, under the control of the first controlling PoC server 116 (symbolized by block 419 in FIG. 4), and the second PoC session proceeds with the first PoC client 101, the fourth PoC client 104 and the fifth client 105 as participants again, under the control of the second controlling PoC server 117 (symbolized by block 420 in FIG. 4).

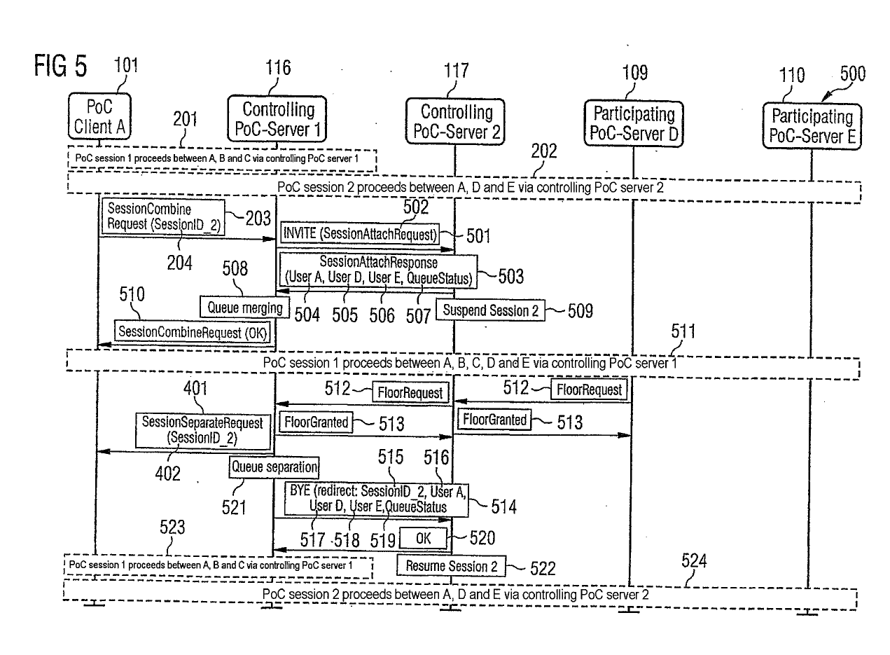

FIG. 5 shows a message flow diagram 500 showing the interchange of Session Initiation Protocol (SIP) messages for forming a common communication session on the basis of a second exemplary embodiment of the invention.

In line with this exemplary embodiment of the invention too, without restricting general validity, the first PoC client 101 of user A signals to the first controlling PoC server 116 that it needs to merge the current PoC session, i.e. the first PoC session, with another PoC session, the second PoC session. This is done using the request message (SessionCombineRequest) 203, which the first PoC client 101 produces and transmits to the first controlling PoC server 116, the PoC session ID of the second PoC session being provided as parameter 204.

Receipt of the request message 203 prompts the first controlling PoC server 116 to produce an SIP-INVITE message 501 and to send this message to the second controlling PoC server 117, the first controlling PoC server 116 using a defined flag 502 (in this case called SessionAttachRequest) in it to notify the second controlling PoC server 117 that this SIP session which is to be set up between the two controlling PoC servers 116, 117 is meant to be used to attach the second PoC session to the first PoC session.

Since the second controlling PoC server 117 is in agreement with this, it responds positively using a positive acknowledgement message 503 and in so doing—as also in line with the first exemplary embodiment of the invention - transmits the list of the current participants of the second PoC session (user A 504 on the first PoC client 101, user D 505 on the fourth PoC client 104 and user E 506 on the fifth PoC client 105) and a piece of information describing the current status of the queue (parameter QueueStatus 507) (optionally, if present), and possibly other parameters describing the status of the second PoC session.

The first controlling PoC server 116 now forms a common communication rights allocation queue (queue) (step 508) in the same way as on the basis of the first exemplary embodiment of the invention.

In addition, the second controlling PoC server 117 interrupts the second PoC session (block 509 in FIG. 5).

The first controlling PoC server 116 then also uses a response message (SessionCombineResponse) 510 to signal to the first PoC client 101 and hence to user A that the merging of the two PoC sessions has been performed successfully.

Now, all the PoC clients 101, 104, 105 from the second PoC session are thus involved in the first PoC session via their respective participating PoC server 106, 109, 110, the second controlling PoC server 117 and the first controlling PoC server 116 (block 511).

As described above, the second controlling PoC server 117 suspends the second PoC session and now acts only as a relay server, interchanging all signaling and media streams (media data streams) between the participating PoC servers 109, 110 from the second PoC session and the first controlling PoC server 116, but no longer performs any other functions.

As an example, FIG. 5 shows how a floor request is handled by user D. The fourth participating PoC server 109 sends a FloorRequest message 512 to the second controlling PoC server 117, which forwards this request to the first controlling PoC server 116. The response message FloorGranted 513 is also sent from the first controlling PoC server 116 to the fourth participating PoC server 109 via the second controlling PoC server 117.

In line with the second exemplary embodiment of the invention, the second PoC session is detached from the first PoC session as follows:

When the first PoC client 101 of user A has again sent a split request message 401 (SessionSeparateRequest) to the first controlling PoC server 116, the latter terminates the SIP session previously set up with the second controlling PoC server 117 using an SIP-BYE message 514. In this case too, the session ID 515 of the original second PoC session is also supplied as a parameter, and likewise the new queue 519 (the queue is split into a queue for the first PoC session and a queue for the second PoC session in step 521) together with a statement indicating the current participants belonging to the second PoC session (first PoC client 101 (first participant 516), fourth PoC client 104 (fourth participant 517), fifth PoC client 105 (fifth participant 518)) is also supplied as a parameter.

The second controlling PoC server 117 acknowledges this with an SIP-200-OK message 520 and resumes the original second PoC session (step 522).

The first PoC session now proceeds with the first PoC client 101, the second PoC client 102 and the third client 103 as participants again, under the control of the first controlling PoC server 116 (symbolized by block 523 in FIG. 5), and the second PoC session proceeds with the first PoC client 101, the fourth PoC client 104 and the fifth client 105 as participants again, under the control of the second controlling PoC server 117 (symbolized by block 524 in FIG. 5).

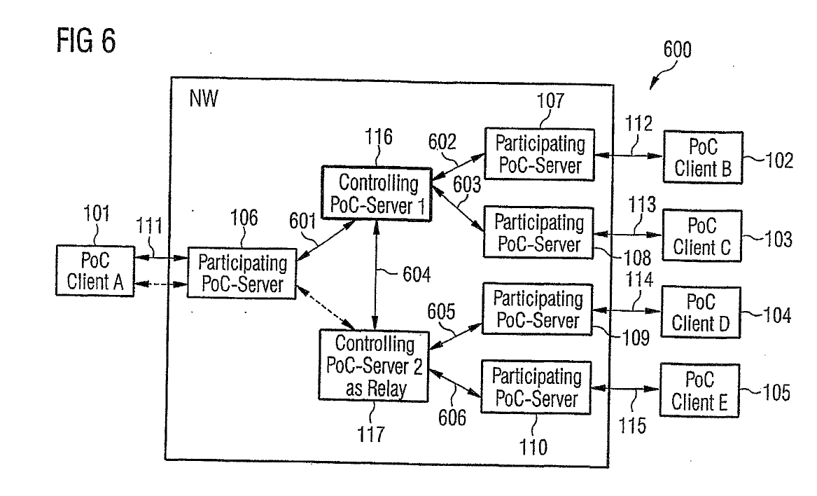

FIG. 6 uses a block diagram 600 to show the state of the communication links in the PoC communication network 100 in terms of the PoC sessions when the first PoC session and the second PoC session have been combined to form the common PoC session in the first PoC session on the basis of the second exemplary embodiment.

The basic structure of the PoC communication network 100 shown in FIG. 6 corresponds to that of the one shown in FIG. 1, but with the communication links between the participating PoC servers 106, 107, 108, 109, 110 and the controlling PoC servers 116, 117 being different. The communication links 111, 112, 113, 114, 115 between the PoC clients 101, 102, 103, 104, 105 and the participating PoC servers 106, 107, 108, 109, 110 are unchanged.

In line with FIG. 6, there is now a communication link 601 between the first participating PoC server 106 and the first controlling PoC server 116 and also a communication link 602, 603 between the second participating PoC server 107 and the first controlling PoC server 116 and between the third participating PoC server 108 and the first controlling PoC server 116.

In addition, there is an SIP communication link 604 between the first controlling PoC server 116 and the second controlling PoC server 117.

In addition, there is a communication link 605, 606 between the fourth participating PoC server 109 and the first controlling PoC server 116 and between the fifth participating PoC server 110 and the second controlling PoC server 117 and via the SIP communication link 604 to the first controlling PoC server 116.

Hence, the fourth PoC client 104 and the fifth PoC client 105 use the same connection to their participating PoC servers as they also used before.

The aspects of the invention which are described above achieve the following advantages, inter alia:
The PoC clients which are temporarily switched to another PoC session require no new functionality, since the functionality required for this is provided by their respective participating PoC servers
When the two PoC sessions have been separated, the respective contexts which existed in the two PoC sessions prior to the merging can be resumed. This means that no information is lost, for example as a result of otherwise necessary termination of one of the two PoC sessions in the meantime.
The alternative based on the second exemplary embodiment of the invention can be generalized as “hierarchic linking of PoC sessions”. By way of example, the second PoC session and the second controlling PoC server would be below the first PoC session and below the first controlling PoC server in the hierarchy in the exemplary embodiment. Such a hierarchy could be continued with a plurality of PoC sessions as desired.

The following aspects of the invention should be additionally pointed out:
Signaling in order to initiate merging of PoC sessions;
Additional SIP sessions between the controlling PoC server for one PoC session and the participating PoC servers for another session (first exemplary embodiment);
Additional SIP session between the controlling PoC servers for two different PoC sessions (second exemplary embodiment);
In this case, the second controlling PoC server plays the part of a pure relay server (second exemplary embodiment);
Merging of the two FloorControl queues to form a common queue on the basis of the principal of alternation;
Signaling in order to terminate merging of PoC sessions again.

1-22. (canceled)

23. A method for forming a common communication session from a first communication session with a plurality of communication session participant communication devices, which are respectively associated with a participant server from a first plurality of participant servers and use the respective participant server to participate in the first communication session, and a second communication session with a plurality of communication session participant communication devices, which are respectively associated with a participant server from a second plurality of participant servers and use the respective participant server to participate in the second communication session, where the first communication session is controlled by a first communication session control server, and where the second communication session is controlled by a second communication session control server, wherein:
a request to combine the communication session participant communication devices in the common communication session prompts one of the two communication session control servers to request a common communication session from the other communication session control server using a fusion request message,
one of the two communication session control servers sets up the common communication session,
the communication session control server setting up the common communication session transmits a fusion message to each of the participant servers in the first plurality of participant servers and/or the second plurality of participant servers, and
the respective participant server associates its associated communication session participant communication device with the common communication session.

24. The method as claimed in claim 23, wherein the request is sent by a communication session participant communication device in the first communication session and/or the second communication session.

25. The method as claimed in claim 23, wherein the first communication session control server sets up the common communication session.

26. The method as claimed in claim 23, wherein the fusion request message contains a communication session identification statement for the second communication session.

27. The method as claimed in claim 23, wherein the second communication session control server sends the first communication session control server an acknowledgement message.

28. The method as claimed in claim 27, wherein the acknowledgement message contains a list of the communication session participant communication devices in the second communication session.

29. The method as claimed in claim 27, wherein the acknowledgement message contains a piece of information about communication rights allocation of the communication session participant communication devices in the second communication session.

30. The method as claimed in claim 29, wherein the piece of information about the communication rights allocation of the communication session participant communication devices in the second communication session has a piece of communication rights queue information which is used to indicate future communication rights allocation of the communication session participant communication devices in the second communication session.

31. The method as claimed in claim 29, wherein communication rights allocation in the common communication session is performed taking into account the piece of information about the communication rights allocation of the communication session participant communication devices in the first communication session and/or the second communication session.

32. The method as claimed in claim 23, wherein the second communication session control server sets up the common communication session.

33. The method as claimed in claim 32, wherein the fusion request message contains a communication session identification statement for the first communication session.

34. The method as claimed in claim 32, wherein the fusion request message contains a list of the communication session participant communication devices in the first communication session.

35. The method as claimed in claim 32, wherein the fusion request message contains a piece of information about communication rights allocation of the communication session participant communication devices in the first communication session.

36. The method as claimed in claim 35, wherein the piece of information about the communication rights allocation of the communication session participant communication devices in the first communication session has a piece of communication rights queue information which is used to indicate future communication rights allocation of the communication session participant communication devices in the first communication session.

37. The method as claimed in claim 35, wherein communication rights allocation in the common communication session is performed taking into account the information about the communication rights allocation of the communication session participant communication devices in the first communication session and/or the second communication session.

38. The method as claimed in claim 23, wherein the Session Initiation Protocol is used for at least some of the messages.

39. The method as claimed in claim 23, wherein the communication sessions are Push-to-talk communication sessions.

40. The method as claimed in claim 39, wherein the communication sessions are Push-to-talk-over-Cellular communication sessions or conferencing communication sessions.

41. A method for forming a first communication session with a plurality of communication session participant communication devices, which are respectively associated with a participant server from a first plurality of participant servers and use the respective participant server to participate in a common communication session, and a second communication session with a plurality of communication session participant communication devices, which are respectively associated with a participant server from a second plurality of participant servers and use the respective participant server to participate in the common communication session, from the common communication session, where the first communication session is controlled by a first communication session control server, and where the second communication session is controlled by a second communication session control server, wherein:
a request to split the communication session participants from the common communication session over the first communication session and the second communication session prompts one of the two communication session control servers to associate the communication session participant communication devices with the first communication session and the second communication session, and one of the two communication session control servers uses a split message to notify the other communication session control server of the splitting of the communication session participant communication devices.

42. A communication session control server for forming a common communication session from a first communication session with a plurality of communication session participant communication devices, which are respectively associated with a participant server from a first plurality of participant servers and use the respective participant server to participate in the first communication session, and a second communication session with a plurality of communication session participant communication devices, which are respectively associated with a participant server from a second plurality of participant servers and use the respective participant server to participate in the second communication session, where the first communication session is controlled by the communication session control server, and where the second communication session is controlled by another communication session control server, the communication session control server having a processor which is configured to perform the following:
request to combine the communication session participant communication devices in the common communication session prompting the communication session control server to request a common communication session from the other communication session control server using a fusion request message;
the communication session control server setting up the common communication session; and
the communication session control server transmitting a fusion message to each of the participant servers in the first plurality of participant servers and/or the second plurality of participant servers which signals to the respective participant server to associate the participant server's associated communication session participant communication device with the common communication session.

43. A communication session control server for forming a common communication session from a first communication session with a plurality of communication session participant communication devices, which are respectively associated with a participant server from a first plurality of participant servers and use the respective participant server to participate in the first communication session, and a second communication session with a plurality of communication session participant communication devices, which are respectively associated with a participant server from a second plurality of participant servers and use the respective participant server to participate in the second communication session, where the first communication session is controlled by the communication session control server, and where the second communication session is controlled by another communication session control server, the communication session control server having a processor which is configured such that receipt of a fusion request message from another communication session control server, which message is used to request a common communication session, prompts it to set up the common communication session and to transmit a fusion message to each of the participant servers in the first plurality of participant servers and/or the second plurality of participant servers which signals to the respective participant server to associate its associated communication session participant communication device with the common communication session.

44. A communication session control server for forming a first communication session with a plurality of communication session participant communication devices, which are respectively associated with a participant server from a first plurality of participant servers and use the respective participant server to participate in a common communication session, and a second communication session with a plurality of communication session participant communication devices, which are respectively associated with a participant server from a second plurality of participant servers and use the respective participant server to participate in the common communication session, from the common communication session, where the first communication session is controlled by the communication session control server, and where the second communication session is controlled by another communication session control server, the communication session control server having a processor which is configured to perform the following:
request to split the communication session participants from the common communication session over the first communication session and the second communication session prompting the communication session control server to associate the communication session participant communication devices with the first communication session and the second communication session; and
the communication session control server using a split message to notify the other communication session control server of the splitting of the communication session participant communication devices.
